(19) United States
(12) Patent Application Publication
(10) Pub. No.: US 2011/0168498 A1
(43) Pub. Date: Jul. 14, 2011

(54) ELEVATOR GROUP CONTROL DEVICE

(75) Inventor: Masaaki Amano, Tokyo (JP)

(73) Assignee: Mitsubishi Electric Corporation, Tokyo (JP)

(21) Appl. No.: 13/063,228

(22) PCT Filed: Oct. 23, 2008
(86) PCT No.: PCT/JP2008/069201

§ 371 Date: Mar. 10, 2011

(51) Int. Cl. B66B 1/20

(52) U.S. Cl. 187/384

(57) ABSTRACT

Provided is an elevator group control device which enables any special operation to be selected from a plurality of kinds of special operations by an operation in an elevator hall or in a place distant from the elevator hall. For this purpose, special operation input means for inputting information to the effect that any special operation is to be performed in the hall or in a place distant from the hall, a notification device which provides prescribed information by indications or sounds are installed in the elevator hall or in a place distant from the elevator hall. An elevator group control panel is provided with special operation storage means in which a plurality of kinds of special operations are stored. When information to the effect that a special operation is to be performed is inputted from the special operation input means, a special operation corresponding to the input information is selected from special operations stored in the special operation storage means, and information about the selected special operation is provided by the notification device.

### TECHNICAL FIELD

The present invention relates to an elevator group control device which is such that a destination floor is registered in an elevator hall and a call assignment is performed according to the registered destination floor.

### BACKGROUND ART

In recent years, a group control device which controls a plurality of elevators as a group has enabled the processing of a large amount of information and high-level control to be realized due to the adoption of microcomputers.

On the other hand, in large-scale office buildings and the like, it is necessary to carry a large number of users who want to move to their destination floors with good efficiency, and hence many proposals to improve the operation efficiency have been made.

For example, when elevators become congested with passengers from a specific floor as in the morning time zone and the lunch time zone, control is performed in such a manner that a plurality of cars are allocated to the floor in order to lessen the congestion. A destination floor registration device which is intended for being used by users in registering their destination floors is installed in an elevator hall, whereby it is ensured that information necessary for group control is inputted before boarding and the assignment accuracy of hall calls and the operation efficiency are improved. That is, when a destination floor registration device is installed in a hall, a destination call is automatically registered in boarding a car and, therefore, it is possible to save the time and labor of operation during boarding. Thus, a destination floor registration device is efficiently used as one of the means of carrying users to their destination floors with good efficiency.

Some proposals have hitherto been made about means of registering destination floors (destination calls) in a hall.

For example, Patent Document 1 below proposes a group control device in which a numerical-key-type destination floor registration device is installed in a hall. In the group control device described in Patent Document 1, when a destination floor has been registered from a destination floor registration device, an elevator assigned to that call is indicated and the position of that assigned elevator in the hall is indicated by an arrow.

Patent Document 2 below describes a group control device in which a destination floor registration device installed in a hall is provided with a registration button for physically-handicapped people. In the group control device described in Patent Document 2, when a destination floor is registered with the operation of the above-described registration button, an assignment to that call is performed in consideration of the time required by the physically-handicapped person in moving to the front of an entrance of an assigned elevator.

Furthermore, Patent Document 3 below describes a group control device in which a numerical-key-type destination floor registration device is installed in a hall and when a destination floor is registered from this destination floor registration device, the registered destination floor and an elevator assigned to the call are indicated side by side.
Patent Document 1: Japanese Patent No. 2563545
Patent Document 2: Japanese Patent No. 3040524
Patent Document 3: Japanese Patent Laid-Open No. 2001-287876

### DISCLOSURE OF THE INVENTION

### Problems to be Solved by the Invention

Patent Documents 1 to 3 above disclose group control devices in which a destination floor registration device is installed in an elevator hall and a call assignment is performed according to a destination floor registered from this destination floor registration device. In the group control devices described in Patent Documents 1 to 3, however, no countermeasures were taken against the problems and phenomena described below.

A. There is not described a technique by use of which only specific users other than general users use an elevator from a hall destination floor registration device.

B. Although it is possible to select a special operation and the like suited to wheelchair users from a hall destination floor registration device, it is impossible for a building manager and other people to select a special operation.

The present invention was made to solve the problems described above, and the object of the present invention is to provide an elevator group control device which permits the selection of any of a plurality of kinds of special operations by an operation from an elevator hall or an operation in a place distant from the elevator hall, does not require cost more than necessary, and is easy to use.

### Means for Solving the Problem

An elevator group control device according to the present invention is an elevator group control device which comprises a hall destination floor registration device which is provided in an elevator hall of a building or in a place distant from the elevator hall and is intended for being used by an elevator user in registering his or her destination floor, a group control panel which controls a plurality of elevators installed in the building as a group and performs a call assignment when a destination floor is registered from the hall destination floor registration device, special operation storage means in which a plurality of kinds of special operations are stored, special operation input means which is provided in the hall or in a place distant from the hall and is intended for inputting information to the effect that any special operation is to be performed from the hall or a place distant from the hall, a notification device which is provided in the hall or in a place distant from the hall and provides prescribed information by indications or sounds, and special operation selection means which, upon input of information to the effect that special operation is to be performed from the special operation input means, selects a special operation corresponding to the input information from special operations stored in the special operation storage means, causes the special operation to be performed, and causes the notification device to provide the information about the selected special operation.

### Effect of the Invention

According to the present invention, in an elevator group control device which is such that a destination floor is registered in an elevator hall and a call assignment is performed according to the registered destination floor, any special operation can be selected from a plurality of kinds of special operations by an operation from an elevator hall or an operation in a place distant from the elevator hall, whereby excessive cost becomes unnecessary and it becomes easy for users to use an elevator.

### BRIEF OF DESCRIPTION OF THE DRAWINGS

FIG. 1 is a block diagram showing an elevator group control device in a first embodiment according to the present invention.

FIG. 2 is a diagram showing an example of the operation of the hall destination floor registration device.

FIG. 3 is a diagram showing another example of the operation of the hall destination floor registration device.

FIG. 4 is a diagram showing another example of the operation of the hall destination floor registration device.

FIG. 5 is a flowchart showing the actions of the elevator group control device in the first embodiment according to present invention.

FIG. 6 is a flowchart showing the actions of the elevator group control device in a second embodiment according to the present invention.

### DESCRIPTION OF SYMBOLS

1 group control panel,
2 control panel,
3 control panel,
4 operation control means,
5 boarding detection means,
6 communication means,
7 car,
8 elevator indication plate,
9 operation control means,
10 boarding detection means,
11 communication means,
14 hall destination floor registration device,
15 destination floor input means,
16 special operation input means,
17 indication means,
18 audio announcement means,
19 destination call assignment means,
20 hall call registration means,
21 destination call automatic registration means,
22 special operation selection means,
23 special operation storage means,
24 operation control means,
25 communication means,
26 clock means,
27 external device

### BEST MODE FOR CARRYING OUT THE INVENTION

The present invention will be described in more detail with reference to the accompanying drawings. Incidentally, in each of the drawings, like numerals refer to like or similar parts and redundant descriptions of these parts are appropriately simplified or omitted.

### First Embodiment

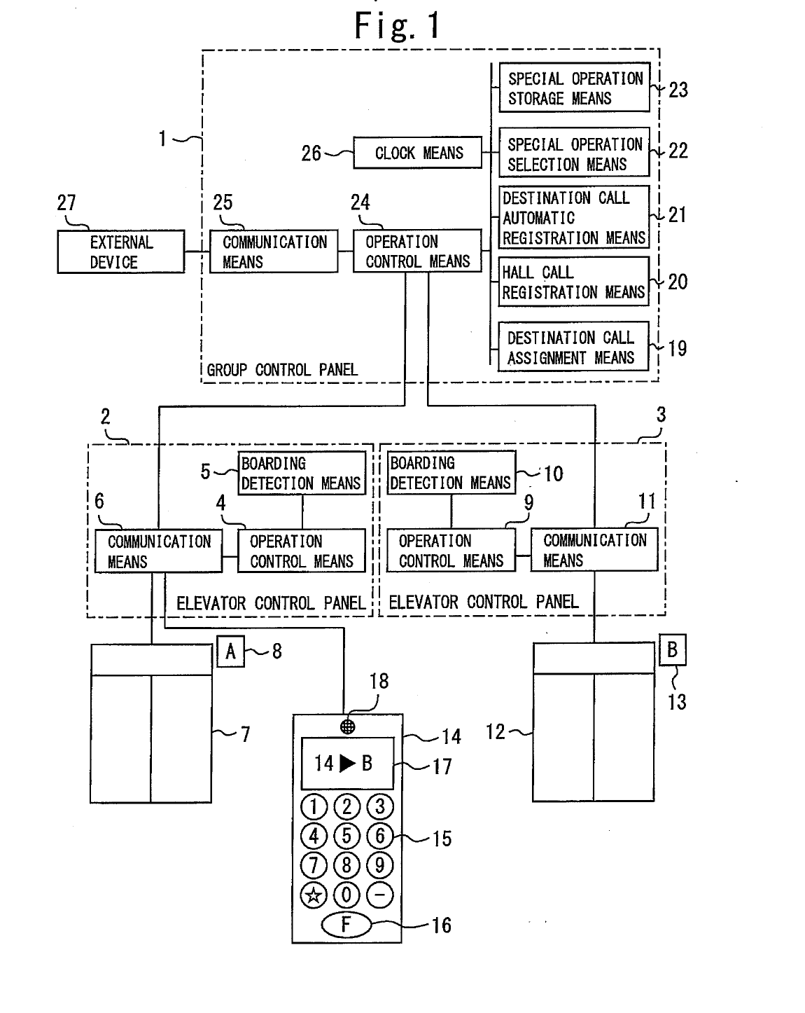

FIG. 1 is a block diagram showing an elevator group control device in a first embodiment according to the present invention. In FIG. 1, reference numeral 1 denotes a group control panel which controls a plurality of elevators installed in an office building and the like as a group. The group of elevators controlled by this group control panel 1 may be all of the elevators installed in a building or may be part of the elevators installed in the building.

Reference numerals 2 and 3 denote control panels for controlling each of the elevators controlled by the group control panel 1. FIG. 1 shows, as the simplest example, the case where the two elevators of Elevator A and Elevator 13 are controlled by the group control panel 1.

The control panel 2 for controlling Elevator A is such that essential parts thereof are composed of, for example, operation control means 4, boarding detection means 5 and communication means 6.

The operation control means 4 takes charge of the whole operation control of the Elevator A including the control of a car 7 of Elevator A. The boarding detection means 5 has the function of detecting the boarding and alighting of users with respect to the car 7. This boarding detection means 5 detects the boarding and alighting of users on the basis of a detection signal from a load weighing device which detects the load of the car 7 or a noncontact-type door sensor. The communication means 6 has the function of performing mutual communication among the group control panel 1, the control panel 2, the car 7 and hall equipment.

Reference numeral 8 denotes an elevator indication plate provided in the hall of Elevator A. This elevator indication plate 8 is intended for indicating the elevator No. and is installed in the vicinity of the entrance of Elevator A. The elevator indication plate 8 may be formed as a mere nameplate or may also be configured to serve also as a hall lantern.

On the other hand, the configuration of Elevator 13 is the same as that of Elevator A. That is, on the control panel 3 which controls Elevator B, there are provided operation control means 9, boarding detection means 10 and communication means 11 which have the same functions as each of the means indicated by reference numerals 4 to 6 above. Reference numeral 12 denotes a car of Elevator B, and an elevator indication plate 13 is provided in the vicinity of the entrance of Elevator B in the hall.

Reference numeral 14 denotes a hall destination floor registration device provided in an elevator hall of the building or in a place distant from the elevator hall. This hall destination floor registration device 14 has the functions of enabling an elevator user present in that installation location to register his or her destination floor before boarding, and performs the sending and receiving of information with the group control panel 1 and the like via the above-described communication means 6.

The hall destination floor registration device 14 is provided with destination floor input means 15, special operation input means 16, indication means 17, and audio announcement means 18.

The destination floor input means 15 is intended for being used by a user in inputting his or her destination floor before boarding, and is composed of, for example, a plurality of numerical-key-type buttons arranged in the middle part of the hall destination floor registration device 14. The destination floor input means 15 shown in FIG. 1 is merely an example and the destination floor input means 15 may have any configuration. For example, the destination floor input means 15 may be composed of a touch panel or can also be configured in combination with an authenticating device.

The special operation input means 16 is intended for being used by a user and other persons in performing a prescribed signal input when the user and other persons desire a special operation. That is, by appropriately operating this special operation input means 16, the user and other persons can input, from the hall, information to the effect that any special operation is to be performed. The above-described special operation means an operation whose control method is different from that of an ordinary operation which is adopted at normal times in order to carry users to their destination floors (hereinafter referred to as “an ordinary operation”).

The special operation input means 16 is constituted by, for example, a special button F arranged in the lower part of the hall destination floor registration device 14. The special operation input means 16 shown in FIG. 1 is merely an example and the special operation input means 16 may have any configuration. For example, the special operation input means 16 may be such that a plurality of special buttons are arranged according to the kinds of special operations, or may also be composed of a touch panel. Also, the special operation input means 16 can be configured in combination with an authenticating device.

The indication means 17 has the function of notifying an operator of the hall destination floor registration device 14 of prescribed information by indicating characters, symbols and the like. This indication means 17 is composed of, for example, a liquid crystal display or the like arranged in the upper part of the hall destination floor registration device 14. Various kinds of information, for example, a registered destination floor, an elevator No. assigned to the call, and a selected operation mode, are indicated on the indication means 17.

The audio announcement means 18 has the function of notifying an operator of the hall destination floor registration device 14 of prescribed information by sounds. When the hall destination floor registration device 14 is provided with other notification means of providing information as in the above-described indication means 17, it is possible to exclude the function of the audio announcement means 18 from the hall destination floor registration device 14.

The hall destination floor registration device 14 having the above-described configuration may be installed only on a floor where congestion is expected as a main floor or may also be installed on all floors to be served by Elevator A and Elevator B or part of the floors.

Next, the configuration and functions of the group control panel 1 will be concretely described.

In addition to its basic function of performing a call assignment upon registration of a destination floor from the hall destination floor registration device 14, the group control panel 1 has also the function of selecting an optimum special operation according to input information and causing an elevator to operate appropriately. In order to provide these functions, the group control panel 1 is such that its essential parts are composed of, for example, destination call assignment means 19, hall call registration means 20, destination call automatic registration means 21, special operation selection means 22, special operation storage means 23, operation control means 24, communication means 25, and clock means 26.

The destination call assignment means 19 has the function of assigning an optimum elevator from the controlled elevators (in the configuration shown in FIG. 1, the car 7 of Elevator A or the car 12 of Elevator B) to the destination call upon registration of a destination floor by an elevator user from the hall destination floor registration device 14.

The hall call registration means 20 has the function of registering a hall call for an assigned car when the assigned car has been determined by the destination call assignment means 19. For example, in the case where Elevator A has been assigned to a destination call from a prescribed hall destination floor registration device 14, the hall call registration means 20 registers a hall call of the installation floor of the hall destination floor registration device 14 where a destination floor registration was performed for the car 7 of Elevator A.

The destination call automatic registration means 21 has the function of automatically registering a destination call at an appropriate timing for an assigned car after the assigned car is determined by the destination call assignment means 19. For example, in the case where Elevator A has been assigned to a destination call from a prescribed hall destination floor registration device 14, the destination call automatic registration means 21 automatically registers the above-described destination call for the car 7 of Elevator A when boarding of the car 7 of Elevator A has been detected on the installation floor of the hall destination floor registration device 14 where a destination floor registration was performed.

The special operation selection means 22 has the function of performing control related to special operations. That is, the group control panel 1 is such that a plurality of kinds of special operations are stored beforehand in the special operation storage means 23. Upon input of information from the special operation input means 16 to the effect that a special operation is to be performed, the special operation selection means 22 selects a special operation corresponding to the input information from special operations stored in the special operation storage means 23, and causes the elevator to which the call was assigned to perform an action of the special operation. At the same time, the special operation selection means 22 causes a notification device in the hall to provide information about the selected special operation.

On the basis of signals from each of the means indicated by reference numerals 19 to 22, the operation control means 24 appropriately performs operation control of the whole elevator system, such as each of the elevators and the hall destination floor registration device 14. Incidentally, the communication means 25 has the function of ensuring that the group control panel 1 performs communication with external device 27, such as a personal computer warning panel, tools for maintenance and a remote monitoring system.

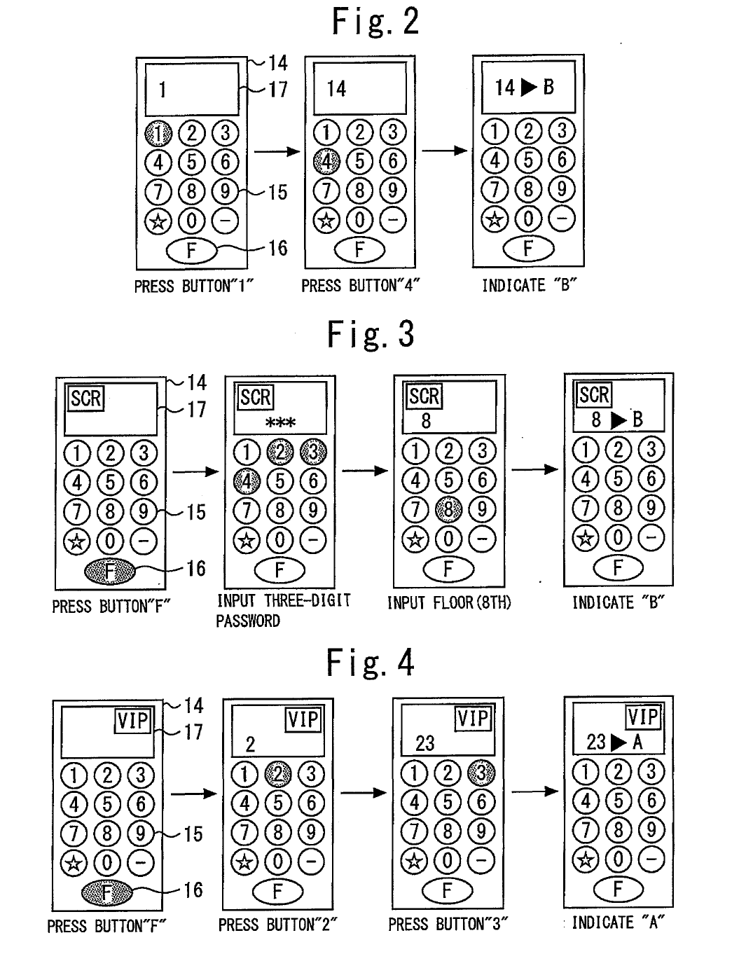

Next, on the basis of FIGS. 2 to 4, examples of the operation of the hall destination floor registration device 14 will be described. FIGS. 2 to 4 are diagrams showing examples of the operation of the hall destination floor registration device, and show the different operations. The audio announcement means 18 is not shown in FIGS. 2 to 4.

First, referring to FIG. 2, an example of an ordinary operation of the hall destination floor registration device 14 will be described.

When an elevator user's destination floor is, for example, the 14th floor, the user inputs the destination floor by sequentially pressing the button “1” and the button “4” of the destination floor input means 15 composed of numerical keys. At this time, the contents of the input are sequentially indicated on the indication means 17. When the destination floor has been fixed at the 14th floor and Elevator B has been assigned to that call, “B” which is the assigned elevator No. is indicated on the indication means 17.

Next, referring to FIGS. 3 and 4, a description will be given of examples of the operation of the hall destination floor registration device 14 involving the operation of the special operation input means 16. FIG. 3 shows an example of the operation in which a secret-call registration is performed.

In FIG. 3, when an elevator user operates the special operation input means 16 composed of a special button F, audio guidance is performed from the audio announcement means 18 and at the same time, a prescribed mark (for example, “SCR”) is indicated on the indication means 17 and the input of a password is required. When the user inputs a password (for example, a three-digit number composed of “234”) at the request, a judgment is made as to whether or not the password is correct. If the password is correct, the input of the destination floor (for example, the 8th floor) is performed, and after the fixing of the destination floor, the elevator No. (for example, “B”) assigned to that call is indicated on the indication means 17.

FIG. 4 shows an example of operation in the case when a VIP carrying operation is selected. In FIG. 4, when an elevator user operates the special operation input means 16 composed of a special button F, audio guidance is performed from the audio announcement means 18 and at the same time, a prescribed mark (for example, “VIP”) is indicated on the indication means 17, and the fact that VIP carrying operation, which is one of special operations, is going to be performed is registered. When the user performs the input of his or her destination floor (for example, the 23rd floor) and the destination floor is fixed, the elevator No. (for example, “A”) assigned to that call is indicated on the indication means 17.

Although in the example of operation shown in FIG. 4 the input of a password is unnecessary, in order to ensure higher security, the input of a password as shown in FIG. 3 may be required before the input of the destination floor.

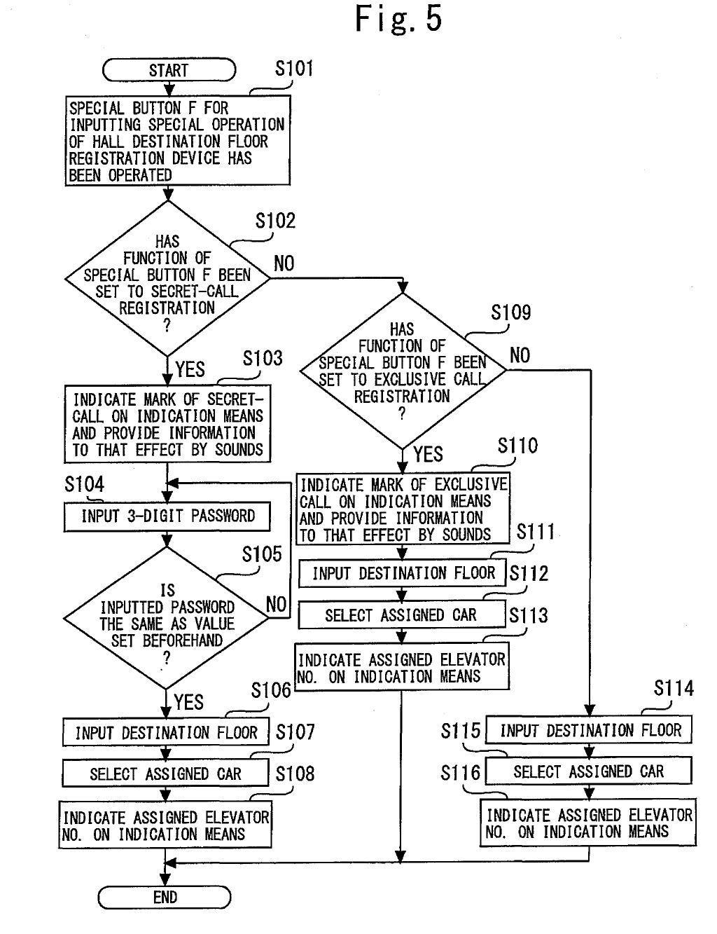

Next, on the basis of FIG. 5, the actions of the elevator group control device having the above-described configuration will be concretely described. FIG. 5 is a flowchart showing the actions of the elevator group control device in the first embodiment according to present invention.

In the hall destination floor registration device 14, when the special button F for inputting a special operation has been operated (S101), first, a judgment is made as to whether or not this function has been set to the secret-call registration (S102). In the case where the secret-call registration has been set as the function of the special button F, in the hall destination floor registration device 14, a mark indicative of the secret-call registration is indicated on the indication means 17 and at the same time, guidance to that effect is performed from the audio announcement means 18 (S103). When a user inputs a three-digit password in accordance with the guidance of S103, for example, as shown in FIG. 3 (S104), the hall destination floor registration device 14 makes a judgment as to whether or not the inputted password is the same as a value set beforehand (S105).

When the user inputs his or her destination floor (S106) after it is judged in S105 that the password coincides, the input information is sent to the group control panel 1 and a car assigned to the call is selected by the destination call assignment means 19 (S107). When the assigned car has been determined, in the hall destination floor registration device 14, the assigned elevator No. is indicated on the indication means 17 and information about the assigned car is provided to the user (S108). When in the judgment in S105 it is judged that the password does not coincide, the flow of operation returns to the processing of S104 and the re-input of the password is required.

On the other hand, when it is judged in S102 that the function of the special button F has not been set to the secret-call registration, in the hall destination floor registration device 14, next, a judgment is made as to whether or not the function of the special button F has been set to the exclusive call registration (S109). In the case where the function of the special button F has been set to the exclusive call registration, in the hall destination floor registration device 14, a mark indicative of the exclusive call registration (for example, “VIP”) is indicated on the indication means 17 and at the same time, guidance to that effect is performed from the audio announcement device 18 (S110). Then, when the input of a destination floor is performed thereafter (S111), the input information is sent to the group control panel 1 and a car assigned to the call is selected by the destination call assignment means 19 (S112). When the assigned car has been determined, in the hall destination floor registration device 14, the assigned elevator No. is indicated on the indication means 17 and information on the assigned car is provided to the user (S113).

When it is judged in S109 that the function of the special button F has not been set to the exclusive call registration, in the hall destination floor registration device 14, the ordinary destination call registration function works. That is, when the user inputs his or her destination floor (S114), the input information is sent to the group control panel 1 and the assigned car is selected (S115). The assigned elevator No. is indicated on the indication means 17 and the provision of information about the assigned car is performed (S116).

According to the first embodiment of the present invention, in an elevator group control device which is such that a destination floor is registered in an elevator hall and a call assignment is performed according to the registered destination floor, it becomes possible to select any special operation from a plurality of kinds of special operations by an operation from the elevator hall. For this reason, it becomes possible to provide an easy-to-use group control device without requiring cost higher than necessary.

In this embodiment, the description was given only of the elevator group control device in which the selection of a special operation is performed from an elevator hall. However, the elevator group control device may also be configured to perform the selection of a special operation on the basis of information other than the information from the special operation input means 16 installed in the hall. In such a case, the special operation selection means 22 is configured to select a special operation also on the basis of input information from external device 27 directly or indirectly connected to the group control panel 1, calendar information stored in the group control panel 1, learning information obtained by learning past operations and the like as well as to select a special operation on the basis of input information from the special operation input means 16.

By providing such a configuration, for example, it becomes possible to select beforehand any one of the operation modes at the time of setting in a factory and to select any special operation after the startup of a system to suit the convenience of a building manager, maintenance personnel and other people. Also, it becomes possible to select any special operation periodically or only as needed.

### Second Embodiment

In this embodiment, the selection of a special operation is performed in consideration of the attributes related to an operator of the special operation input means 16. In order to provide the above-described function, the special operation input means 16 is configured to be able to input the attributes related to the operator. Also, on the basis of the information inputted from the special operation input means 16 to the effect that a special operation is to be performed and attribute information about the operator, the special operation selection means 22 performs the selection of a special operation. That is, the special operation selection means 22 selects a special operation corresponding to the input information including the above-described attribute information from special operations stored in the special operation storage means 23, and causes the elevator to which a call is assigned to perform the action of the special operation.

Other configurations are the same as those of the first embodiment.

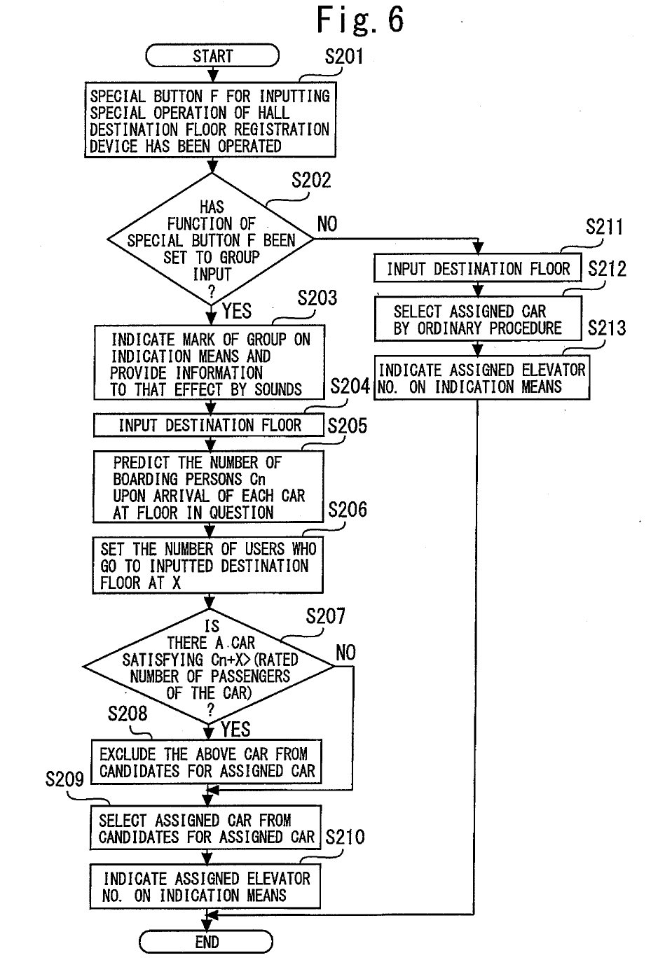

Next, on the basis of FIG. 6, the actions of the elevator group control device having the above-described configuration will be concretely described. FIG. 6 is a flowchart showing the actions of the elevator group control device in a second embodiment according to the present invention. In the following, for the above-described attributes related to the operator, the case where a group use has been set will be described.

In the hall registration device 14, when the special button F for inputting a special operation has been operated (S201), first, a judgment is made as to whether or not the function has been set to the group input (S202). In the case where the group input has been set as the function of the special button F, in the hall destination floor registration device 14, a mark indicative of the group input is indicated on the indication means 17 and at the same time, guidance to that effect is performed from the audio announcement means 18 (S203).

When the input of a destination floor is performed thereafter (S204), the destination floor information, along with the group use information, is sent to the group control panel 1, and an optimum assignment is performed in which the above-described group use (that is, there are multiple persons who go to the destination floor) is considered.

Concretely, in the group control panel 1, first, the number of boarding persons Cn in the car on the arrival at the hall where the special button F was operated is predicated and computed for each elevator (S205). Next, a judgment is made as to whether there is a car satisfying Expression 1 below, in which the number of users who go to the destination floor inputted in S204 is set at X (S206, S207).

Cn+X>rated number of passengers of the car (1)

An elevator (a car) satisfying the condition of Expression 1 above is excluded from candidates for an assigned car and an optimum car is selected as an assigned car from the remaining candidates for an assigned car (S208, S209). In S206, for example, a predetermined value is adopted as the number of users X. The configuration may be such that a value adopted as X above is capable of being changed from the external device 27 or is automatically changed by the calendar function or the learning function. When the assigned car is selected, the assigned elevator No. is indicated on the indication means 17 (S210).

On the other hand, when it is judged in S202 that the function of the special button F has not been set to the group input, in the hall destination floor registration device 14, the ordinary destination floor registration function works. That is, when a user inputs his or her destination floor (S211), the input information is sent to the group control panel 1 and an assigned car is selected by an ordinary procedure (S212). The assigned elevator No. is indicated on the indication means 17 and the information about the assigned car is provided (S213).

According to the second embodiment of the present invention, it becomes possible to select an optimum special operation in consideration of attributes related to an operator of the special operation input means 16, and it becomes possible to provide a group control device which is easier to use.

In the flow of actions shown in FIG. 6, the input of a password is not required after the operation of the special operation input means 17. However, in order to prevent operations by mischief, a function similar to the function working during the secret-call registration may be added.

In each of the above embodiments, the description was given of the group control device which controls a plurality of elevators as a group. However, for a control device which controls one elevator, the same effect can be realized by a configuration similar to the above-described configuration. Group control devices of the above-described configuration can be applied not only to office buildings, but also to, for example, large-scale condominium buildings and hotels.

### INDUSTRIAL APPLICABILITY

The elevator group control device according to the present invention can be applied to elevator group control devices which are such that a destination floor is registered in an elevator hall and a call assignment is performed according to the registered destination floor.

1-3. (canceled)

4. An elevator group control device, comprising:
a hall destination floor registration device which is provided in an elevator hall of a building or in a place distant from the elevator hall and is intended for being used by an elevator user in registering his or her destination floor;
a group control panel which controls a plurality of elevators installed in the building as a group and performs a call assignment when a destination floor is registered from the hall destination floor registration device;
special operation storage means in which a plurality of kinds of special operations are stored;
a special button device which is installed in the hall destination floor registration device and carries out a special operation when operated;
a notification device which is installed in the hall destination floor registration device and provides prescribed information indicative of the kind of the special operation by indications or sounds; and
special operation selection means which, upon operation of the special button device, selects a special operation corresponding to the input information from the special button device from special operations stored in the special operation storage means, causes the special operation to be performed, and causes the notification device to provide the information about the selected special operation.

5. The elevator group control device according to claim 4, further comprising:
password input means which is installed in the hall destination floor registration device to input a password corresponding to the special operation;
password judgment means which judges whether or not the password inputted from the password input means is correct; and
destination floor input approval means which approves the input of a destination floor when the password is judged to be correct by the password judgment means.

6. The elevator group control device according to claim 4, further comprising:
the special button device which is installed in the hall destination floor registration device and is capable of a group input;
information sending means which, upon input of a destination floor after operation of the special button device, sends from the hall destination floor registration device to the group control panel, information about boarding of multiple persons and the hall destination call from a floor where the hall destination floor registration device is installed to the destination floor;
prediction means which predicts the number of boarding persons on the arrival of each car at the floor where the hall destination floor registration device is installed;
excess judgment means which regards the information received from the information sending means as hall destination floor registration of the predetermined number of passengers in group use, and makes a judgment as to whether or not a sum of the predetermined number of passengers in group use and the number of boarding persons of each car predicted by the prediction means exceeds the rated number of passengers of the car; and
assigned car selection means which excludes a car for which the rated number is judged to be exceeded by excess judgment means from candidates for an assigned car, and selects a car assigned to the hall destination call received from the information sending means from the candidates for an assigned car.

7. The elevator group control device according to claim 4, wherein
the special operation selection means selects a special operation on the basis of input information from the special button device, and also selects a special operation on the basis of at least any one of information among input information from an external device connected to the group control panel, calendar information stored in the group control panel, and learning information obtained by learning past operations.

8. The elevator group control device according to claim 4, wherein
the special button device is configured such that attributes related to an operator can be inputted; and
the special operation selection means selects a special operation on the basis of input information from the special button device in consideration of the attributes of the operator.
